(19) United States
(12) Patent Application Publication
(10) Pub. No.: US 2022/0065318 A1
(43) Pub. Date: Mar. 3, 2022

(54) CAGED SPRING ASSEMBLY

(71) Applicant: HONEYWELL INTERNATIONAL INC., Morris Plains, NJ (US)

(72) Inventors: Daniel Petschow, Gilbert, AZ (US); Stephen Abel, Chandler, AZ (US); Kevin Gardner, Tempe, AZ (US)

(73) Assignee: HONEYWELL INTERNATIONAL INC., Morris Plains, NJ (US)

(21) Appl. No.: 17/006,372

(22) Filed: Aug. 28, 2020

(51) Int. Cl. F16F 1/12

(52) U.S. Cl. CPC F16F 1/122

(57) ABSTRACT

In exemplary embodiments, a caged spring assembly is provided that includes a first end cap, a second end cap, a helical spring, and a locking post. The second end cap is opposite the first end cap. The helical spring extends between the first and second end caps. The locking post is disposed inside the helical spring between the first and second end caps. The locking post allows limited compression of the helical spring and prevents extension of the helical spring beyond a set point.

### STATEMENT REGARDING FEDERALLY SPONSORED RESEARCH OR DEVELOPMENT

This invention was made with Government support under contract number PC 1793496 with NASA. The Government has certain rights in the invention.

### TECHNICAL FIELD

The technical field generally relates to the field of spring assemblies, including spring assemblies for gimbal devices and/or other devices.

### BACKGROUND

Spring assemblies may be utilized in a number of different applications, including for example gimbal devices and/or any number of other devices and/or systems. However, existing spring assemblies may not always provide optimal deflection resistance and/or restoring force in applicable direction(s) in certain applications.

Accordingly, it is desirable to provide assemblies and apparatuses for spring assemblies, for example with applicable deflection resistance and/or restoring force in applicable direction(s) for certain applications, such as for example a gimbal device. Furthermore, other desirable features and characteristics of the present invention will become apparent from the subsequent detailed description of the invention and the appended claims, taken in conjunction with the accompanying drawings and this background of the invention.

### SUMMARY

In exemplary embodiments, a caged spring assembly is provided that includes a first end cap, a second end cap, a helical spring, and a locking post. The second end cap is opposite the first end cap. The helical spring extends between the first and second end caps. The locking post is disposed inside the helical spring between the first and second end caps. The locking post allows limited compression of the helical spring and prevents extension of the helical spring beyond a set point.

Also in exemplary embodiments, a rotational apparatus is provided that includes a rotational platform and a plurality of caged spring assemblies. Each of the plurality of caged spring assemblies is coupled to the rotational platform, and includes a first end cap, a second end cap, a helical spring, and a locking post. The second end cap is opposite the first end cap. The helical spring extends between the first and second end caps. The locking post is disposed inside the helical spring between the first and second end caps. The locking post allows limited compression of the helical spring and prevents extension of the helical spring beyond a set point. In certain embodiments, the plurality of caged spring assemblies provide a preload to neutral feature for the apparatus; and the rotational apparatus is configured to accommodate a degree of misalignment of two axially mating connector halves.

### DESCRIPTION OF THE DRAWINGS

The present disclosure will hereinafter be described in conjunction with the following drawing figures, wherein like numerals denote like elements, and wherein:

FIG. 1 is a perspective view of a caged spring assembly, in accordance with an exemplary embodiment;

FIG. 2 is a cross section view of an inner portion of the caged spring assembly of FIG. 1, in accordance with an exemplary embodiment;

FIG. 3 is a perspective view of the caged spring assembly of FIG. 1, depicted with spring hidden for clarity, in accordance with an exemplary embodiment;

FIG. 4 is a top view of an end cap of the caged spring assembly of FIG. 1, in accordance with an exemplary embodiment;

FIG. 5 is a bottom view of an end cap of the caged spring assembly of FIG. 1, in accordance with an exemplary embodiment;

FIG. 6 is a side view of an inner portion of the caged spring assembly of FIG. 1, as installed with a rotational platform in accordance with an exemplary embodiment;

FIG. 7A is a side view of multiple caged spring assemblies of FIG. 1, as installed with a rotational platform in a neutral position, in which a right caged spring assembly and a left caged spring assembly both contact the rotational platform, in accordance with an exemplary embodiment;

FIG. 7B is a side view of multiple caged spring assemblies of FIG. 1, as installed with a rotational platform in a second position, in which a right caged spring assembly contacts the rotational platform, and a left caged spring assembly does not contact the rotational platform, in accordance with an exemplary embodiment;

FIG. 7C is a side view of multiple caged spring assemblies of FIG. 1, as installed with a rotational platform in a third position, in which a left caged spring assembly contacts the rotational platform, and a right caged spring assembly does not contact the rotational platform, in accordance with an exemplary embodiment;

FIG. 8 is a top perspective view of a rotational assembly with a rotational platform and multiple caged spring assemblies of FIG. 1 installed against the rotational platform, in accordance with an exemplary embodiment;

FIG. 9 is a graphical plot showing restoring torque versus degrees tilt of the rotational assembly of FIGS. 7A, 7B, 7C, and FIG. 8, in accordance with an exemplary embodiment;

FIG. 10 is a top perspective view of a gimbal assembly corresponding to the rotational assembly of FIGS. 7A, 7B, 7C, and FIG. 8, in accordance with an exemplary embodiment;

FIG. 11 is a side perspective view of the gimbal assembly of FIG. 10, in accordance with an exemplary embodiment; and

FIG. 12 is a simplified representation of the rotational assembly of FIGS. 7 and 8 as utilized in conjunction with two mating connector halves of a device, such as a fluid coupler of spacecraft, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

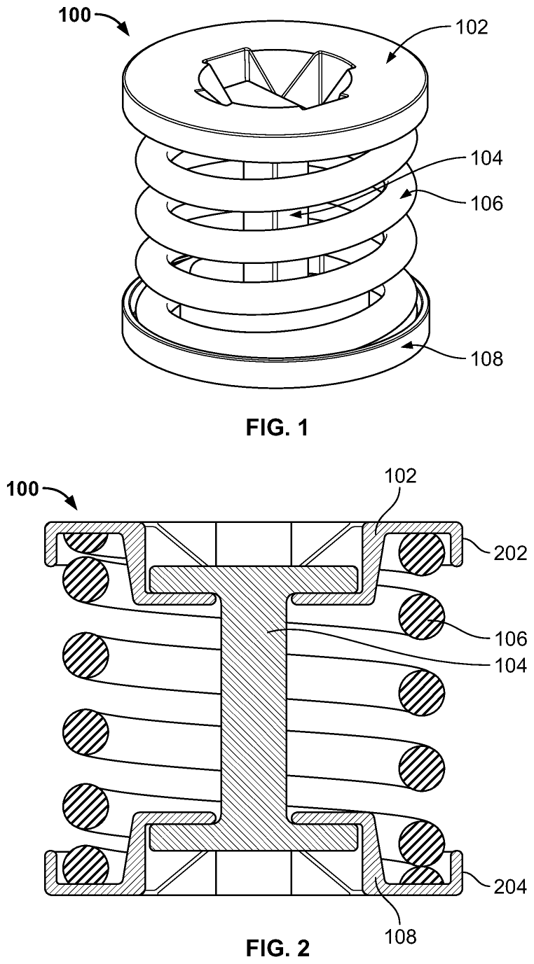

FIG. 1 is a perspective view of a caged spring assembly 100, in accordance with an exemplary embodiment. As depicted in various embodiments, the caged spring assembly 100 includes a first (or top) end cap 102, a locking post 104, a spring 106, and a second (or bottom) end cap 108. As depicted in FIG. 1, in various embodiments, the first end cap 102 and the second end cap 108 are disposed opposite one another. Also as depicted in FIG. 1, in various embodiments, the spring 106 comprises a helical compression spring, and extends between the first and second end caps 102, 108. In addition, in various embodiments, the locking post 104 is disposed inside the helical spring 106 between the first and second end caps 102, 108. In addition, in various embodiments, the locking post 104 allows limited compression of the helical spring 106, and prevents extension of the helical spring 106 beyond a set point.

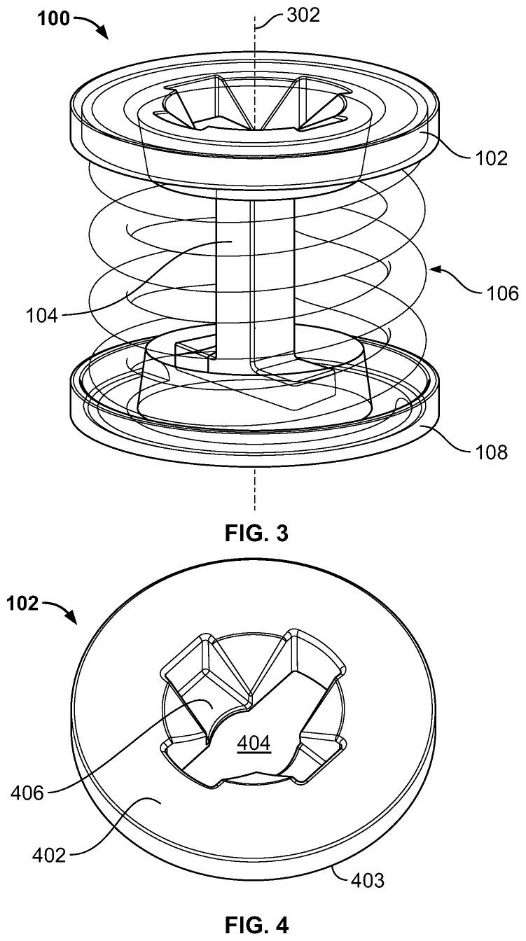

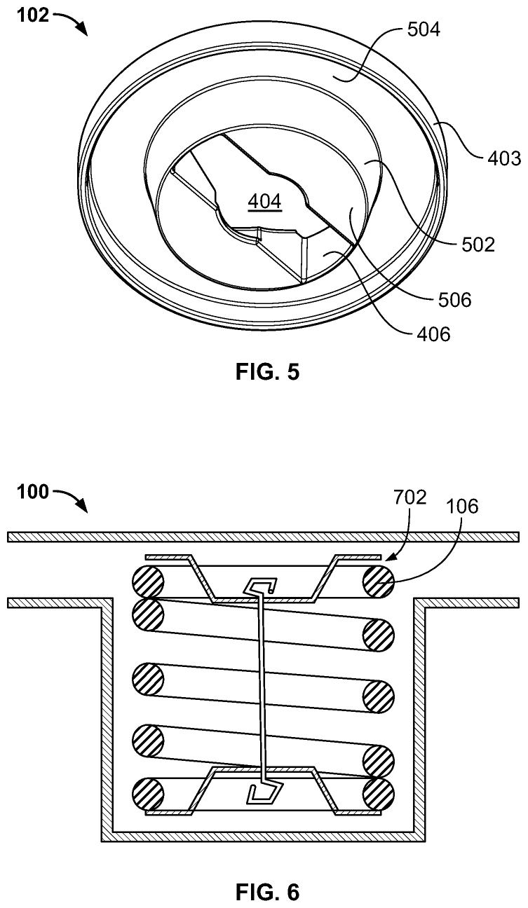

FIGS. 2-4 depict different exemplary views of the caged spring assembly 100 of FIG. 1, in accordance with an exemplary embodiment. Specifically: (i) FIG. 2 is a cross-section view of an inner portion of the caged spring assembly 100 of FIG. 1, in accordance with an exemplary embodiment; (ii) FIG. 3 is a perspective view of the caged spring assembly 100 of FIG. 1, in accordance with an exemplary embodiment; (iii) FIG. 4 is a top view of the first (or top) end cap 102 of the caged spring assembly 100 of FIG. 1, in accordance with an exemplary embodiment; and (iv) FIG. 5 is a bottom view of the first (or top) end cap 102 of the caged spring assembly 100 of FIG. 1, in accordance with an exemplary embodiment.

As noted above, FIG. 2 depicts an inner portion of the caged assembly 100 of FIG. 1, in accordance with an exemplary embodiment. As depicted in FIG. 2, both the locking post 104 and the helical spring 106 contact the top end cap 102 and the bottom 108 at different respective locations. In various embodiments, the helical spring 106 cannot be extended further from the state shown in FIG. 2.

Also as noted above, FIG. 3 is a perspective view of the caged spring assembly 100 of FIG. 1, in accordance with an exemplary embodiment. As depicted in FIG. 3, the caged spring assembly 100 provides restoring force along a single axis (namely, axis 302 as depicted in FIG. 3), and does not provide restoring force along any other axes (e.g., does not provide restoring force in any orthogonal axes).

In addition, in various embodiments, there is a predetermined level of pre-load force in the helical spring 106. In various embodiments, when implemented as a caged spring assembly, the helical spring 106 is compressed to a certain height (e.g., corresponding to the distance between the end caps of FIG. 2) and then held there by the locking post 104 through the middle of the first and second end caps 102, 108. Accordingly, in various embodiments, once a rotational platform (e.g., as depicted in FIGS. 6-8) is placed on top of the caged spring assembly 100 with the pre-loaded helical spring 106, then the caged spring assembly 100 resists (i.e., provides a resisting) force only when the platform is rotated to compress the helical spring 106 further. For example, when a force is applied to the platform that would otherwise move the caged spring assembly 100 away from this position (i.e., away from the already compressed state), then the locking post 104 prevents the helical spring 106 from extending further, and still making contact and putting force against the rotating platform.

Also as noted above, in accordance with an exemplary embodiment: FIG. 4 is a top view of the first (or top) end cap 102 of the caged spring assembly 100 of FIG. 1; and FIG. 5 is a bottom view of the first (or top) end cap 102 of the caged spring assembly 100 of FIG. 1. As depicted in FIG. 4, the first (or top) end cap 102 includes an upper surface 402, a first side surface 403, an opening 404, and a plurality of grooves 406, in an exemplary embodiment. In addition, also in an exemplary embodiment, as depicted in FIG. 5, the first (or top) end cap 102 also includes a first inner surface 502, a second side surface 504, and a second inner surface 506. In various embodiments, the opening 404 is formed in the upper surface 402, and the plurality of grooves 406 are formed in the upper surface 402 and surround the opening 404.

As depicted in FIGS. 4 and 5, in various embodiments, the first side surface 403 contacts, extends from, and is perpendicular to the upper surface 402. In addition, in various embodiments, the second side surface 502 is concentric with the first side surface 403 (and within the first side surface 403). Also in various embodiments, a first inner surface 504 extends between the first and second side surfaces 403, 502, and a second inner surface 506 extends between the second side surface 502 and the opening 404. In various embodiments, the opening 404 and the grooves 406 are for assembling the caged spring assembly 100. In various embodiments, the opening 404 and the grooves 406 are sized to prevent the locking bar and end caps from coming apart when the caged spring assembly 100 is assembled into a ‘gimbal’ mechanism (described further below), and a rotational platform (also described further below) is deflected to the limits of its rotational stroke. In addition, in various embodiments, the caged spring assembly 100 is manufactured with the locking post 104 and slot geometry of the end caps 102, 108, such that the entire geometry is sized to allow assembly of the caged spring assembly 100, while preventing unintentional disassembly of the elements of the caged spring assembly 100 while in use at the next level assembled mechanism.

FIG. 6 is a side view of an inner portion of the caged spring assembly 100 of FIG. 1, as installed with a rotational platform 702 in accordance with an exemplary embodiment. As shown in FIG. 6, in various embodiments, there is no extension of the helical spring 106 beyond the rotational platform 702, and compression starts for the helical spring 106 after a pre-load for the helical spring 106 is exceeded.

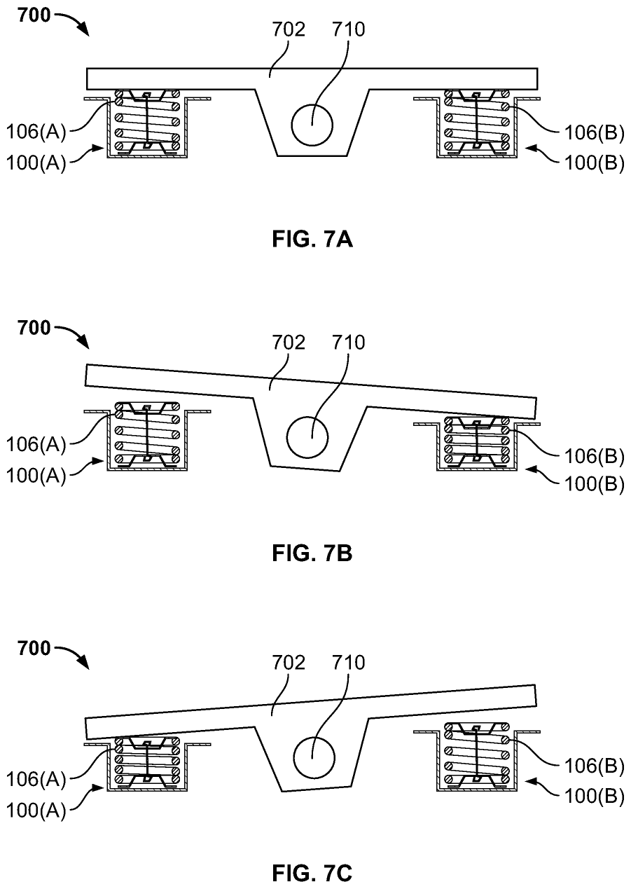

FIGS.7A, 7B, and 7C provide various respective views of an apparatus 700 having multiple caged spring assemblies 100(A) and 100(B) (both corresponding to different caged spring assemblies 100 of FIG. 1, and each having a respective helical spring 106(A), 106(B)) installed in different respective positions with respect to rotational platform 702, in accordance with an exemplary embodiment. As depicted in FIGS. 7A, 7B, and 7C, for ease of reference, caged spring assembly 100(A) is referred to as a first (or left) caged spring assembly 100(A); and caged spring assembly 100(B) is referred to as a second (or right) caged spring assembly 100(B).

In various embodiments, when the rotational platform 702 is disposed in the first position of FIG. 7A (e.g., in which the rotational platform 702 is in a neutral equilibrium position due to the forces from the left and right caged spring assemblies 100(A), 100(B)), the helical spring 106(B) of the right caged spring assembly 100(B) and the helical spring 106(A) of the left spring assembly 100(A) both contact the rotational platform 702. In contrast, when the rotational platform 702 is disposed in the second position of FIG. 7B (e.g., in which the rotational platform 702 is rotated clockwise from neutral the right caged spring assembly 100(B), the helical spring 106(B) of the right caged spring assembly 100(B) contacts the rotational platform 702, and the helical spring 106(A) of the left caged spring assembly 100(A) does not contact the rotational platform 702. In further contrast, when the rotational platform 702 is disposed in the third position of FIG. 7, for example in which the rotational platform 702 is rotated counterclockwise from neutral, the helical spring 106 of the left caged spring assembly 100(A) contacts the rotational platform 702, and the helical spring 106 of the right caged spring assembly 100(B) does not contact the rotational platform 702.

With further reference to FIGS. 7A, 7B, and 7C, in various embodiments, for both of the caged spring assemblies 100(A) and 100(B), the respective helical spring 106(A) or 106(B) is compressed to a certain height and then held there by the locking plate 104 (of FIGS. 1-3) through the middle of the two end caps 102, 108 of FIGS. 1-3. Specifically, in various embodiments, for both of the caged spring assemblies 100(A) and 100(B), a certain level of pre-load force has been applied to the helical spring 106, and once the rotational platform 702 is placed on top of the pre-loaded helical spring106, it resists/provides a resisting force only when the rotational platform 702 attempts to rotate in a direction that would attempt to compress the helical spring 106 further. Conversely, in various embodiments, when an attempt is made to rotate the rotational platform 702 away from this position (i.e., away from the already compressed state of the helical spring 106), then the locking plate 104 prevents the helical spring 106 from extending further.

Accordingly, in various embodiments, when a restoring torque is to be applied around rotational axis 710 (e.g., extending in and out of the page in FIGS. 7A, 7B, and 7C), with only one of the helical springs 106(A), 106(B) (but not both) in contact with the rotational platform 702, the helical spring 106 in contact with the rotational platform 702 provides the full benefit of the restoring moment, rather than having both helical springs 106 offset one another to some degree. Specifically, in various embodiments, the compressed helical spring 106 provides the full benefit of the restoring moment, without any competing moment from the other helical spring 106.

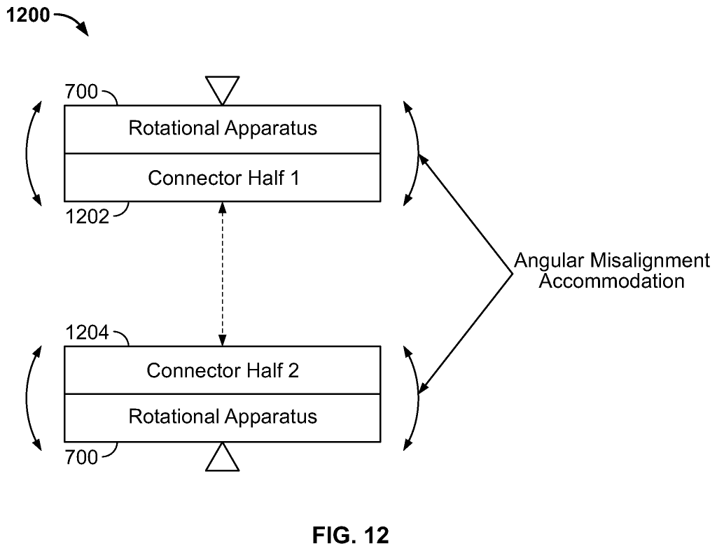

Also in various embodiments, the apparatus 700 of FIGS. 7A, 7B, and 7C is part of a mechanism to accommodate misalignment of two axially mating connectors. For example, with reference to FIG. 12, an exemplary simplified depiction is provided showing the rotational apparatus 700 coupling two mating connector halves (namely, a first mating connector half 1202 and a second mating connector half 1204) together as part of an assembly 1200. In certain embodiments, the first and second mating connector halves 1202, 1204 comprise axially mating connectors of a fluid transfer coupler used on or in connection with spacecraft, for example of a fluid transfer coupler for a lunar gateway station.

In certain embodiments, the two axially mating connectors 1202, 1204 may have respective axes that are not perfectly co-linear. Therefore, as the two mating connectors 1202, 1204 begin to mate, there may be some offset to their relative positions.

In various embodiments, the apparatus 700 (with the multiple caged spring assemblies 100(A), 100(B)) accommodates for this offset. Accordingly, in various embodiments, the apparatus 700 (with the multiple caged spring assemblies 100(A), 100(B)) accommodates some degree of freedom to rotate and realign the mating connectors (e.g., first and second mating connectors 1202, 1204 of FIG. 12) as the mating connectors are moved closer together.

With continued reference to FIGS. 7A, 7B, and 7C, in various embodiments, the rotational assembly 700 provides a “preload to neutral” feature. For example, in various embodiments, the rotational platform 702 can be thought of as the plane by which a fluid coupler (or, in certain embodiments, an electrical coupler, and/or one or more other couplers) is mounted. For example, in certain embodiments, the two connectors may not be exactly lined up and collinear, and may need to be rotated with respect to one another. In certain embodiments, in such situations, rotational platform 702 may rotate about axis 710 to accommodate some misalignment with the mating other half of the connector, and so on.

For example, with reference again to FIG. 7B, in this situation, the helical spring 106(B) of the right caged spring assembly 100(B) is compressed, while the helical spring 106(A) of the left caged spring assembly 100(A) is free. In this example, the helical spring 106(B) of the right caged spring assembly 100(B) exerts an upward force on the underside of the rotational platform 702, which would be a force that would be attempting to return the rotational platform 702 to a horizontal level position (i.e., to the position of FIG. 7A). Meanwhile, as the helical spring 106(B) of the right caged spring assembly 100(A) is exerting this upward force, the helical spring 106(A) of the left caged spring assembly 100(A) is not exerting an upward force, because helical spring 106(A) is not contacting the underside of the rotational platform 702, which is due to the fact that the locking plate 104 precludes helical spring 106(A) from extending to its normal height (due to the caged spring feature).

Conversely, with reference again to FIG. 7C, in this situation, the helical spring 106(A) of the left caged spring assembly 100(A) is compressed, while the helical spring 106(B) of the right caged spring assembly 100(B) is free. In this example, the helical spring 106(A) of the left caged spring assembly 100(A) exerts an upward force on the underside of the rotational platform 702, which would be a force that would be attempting to return the rotational platform 702 to a horizontal level position (i.e., to the position of FIG. 7A) by rotating around the axis 710. Meanwhile, as the helical spring 106(A) of the left caged spring assembly 100(A) is exerting this upward force, the helical spring 106(B) of the right caged spring assembly 100(B) is not exerting an upward force, because helical spring 106(B) is not contacting the underside of the rotational platform 702, which is due to the fact that the locking plate 104 precludes helical spring 106(B) from extending to its normal height (due to the caged spring feature).

Accordingly, in various embodiments, the rotational platform 702 may be rotated either clockwise or counterclockwise to accommodate the misalignment. In various embodiments, after the misalignment is accommodated, the platform 702 may be restored to its horizontal, level position (e.g., the position of FIG. 7A).

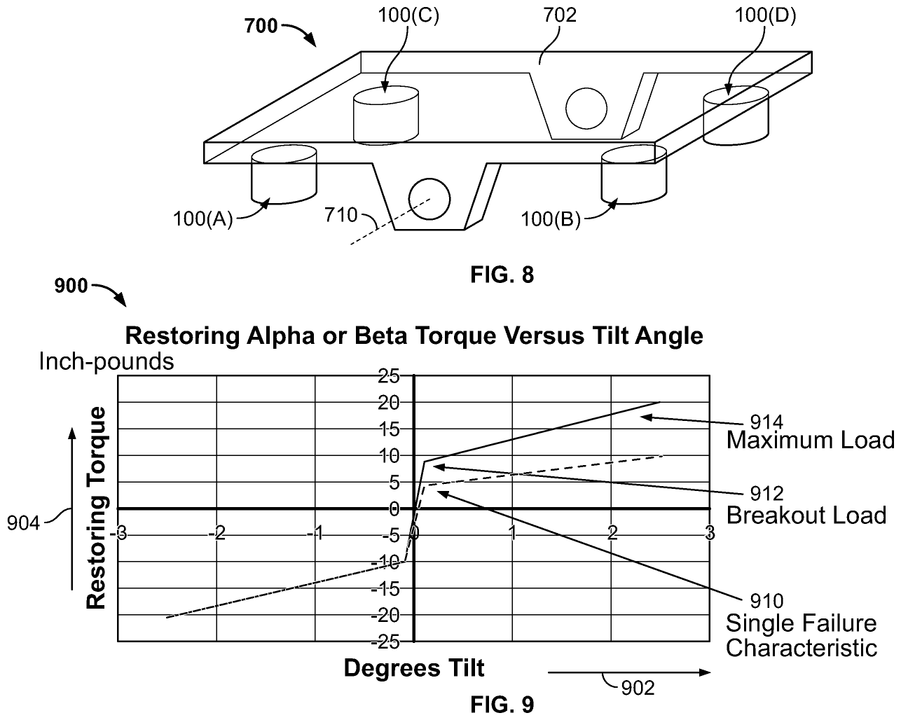

In various embodiments, the rotational assembly 700 may include any number of caged spring assemblies 100. For example, as depicted in FIG. 8, in various embodiments the rotational assembly 700 may include four caged spring assemblies 100. These four caged spring assemblies 100 may include the first and second caged spring assemblies 100(A) and 100(B) as seen in the view of FIGS. 7A, 7B, and 7C, as well as third and fourth caged spring assemblies 100(C) and 100(D) (e.g., on an opposite of the rotational platform 702). In an exemplary embodiment, each of the four cages spring assemblies 100(A), 100(B), 100(C), and 100(D) are connected underneath a respective, different corner of the rotational platform 702, as illustrated in FIG. 8.

In certain embodiments, the rotational assembly 700 of FIGS. 7A, 7B, 7C, and FIG. 8 are utilized in coupling mating components of a fluid transfer coupler, for example in spacecraft and/or for a lunar gateway station. In various embodiments, with a lunar gateway station for orbiting the moon, there is a need to be able to deliver individually launchable modules of the lunar gateway station out into space and then be able to connect the individually launchable modules to each other to build this lunar gateway station and/or to assemble it in space, without direct human involvement at the location. In various embodiments, once the two halves of the fluid transfer coupler are connected together via the rotational assembly 700, the passing of fluids is enabled between the individually launchable modules that have been assembled in space. In various embodiments, the rotational assembly 700 comprises a sub-assembly that is part of a larger assembly that is connected to the fluid transfer coupler, and that allows it to be axially aligned so that the connectors connect together in space. In various embodiments, the rotational assembly 700 helps to accommodate the lack of perfect alignment of the two mating connector halves when joining large pieces of a lunar gateway station, without a human being available to be in the loop and hold the components, and so on.

While the rotational assembly 700 is configured for implementation in spacecraft in certain embodiments, in certain other embodiments the rotational assembly 700 may also be implemented in other implementations. For example, in various embodiments, the rotational assembly 700 may also be implemented in connection with joysticks, pilot controls (e.g., of spacecraft, aircraft, and/or other vehicles), antennas, and so on.

FIG. 9 is a graphical plot 900 showing restoring torque versus degrees tilt of the rotational assembly 700 of FIGS. 7A, 7B, 7C, and FIG. 8, in accordance with an exemplary embodiment. Specifically, FIG. 9 depicts the degrees of angular tilt (in degrees) along the x-axis 902, and the restoring torque (in inch-pounds, or in-lb) along the y-axis 904. In various embodiments, these values correspond to the angular and restoring torque values of the rotational assembly 700 of FIGS. 7A, 7B, 7C, and FIG. 8. Specifically, in various embodiments, the y-axis 904 represents the restoring load to move the rotational platform 702 toward its horizontal position of FIG. 7A. Also in various embodiments, the x-axis 902 represents the degrees of tilt from horizontal in either the clockwise or counterclockwise direction, depending on whether a particular point is positive (+) or negative (−) on the x-axis scale.

As illustrated in FIG. 9, the rotational assembly 700 is accommodating of a spring failure. Specifically, in one embodiment, line 910 refers to a single failure characteristic for the condition where one of the helical springs 106 has failed. Generally, the restoring torque would follow the line corresponding to the breakout load 912 and the maximum load 914. However, if one of the helical springs 106 of FIG. 8 breaks and/or exhibits a failure while in service, then a compromised restoring torque is provided by the other helical spring(s) 106 that are still unbroken. Accordingly, in an exemplary embodiment, this characteristic would shift from the line of 912, 914 to the line of 910 in terms of the restoring force for the rotational assembly 700. Accordingly, with two helical springs 106 on either side, this provides accommodation of a single spring failure.

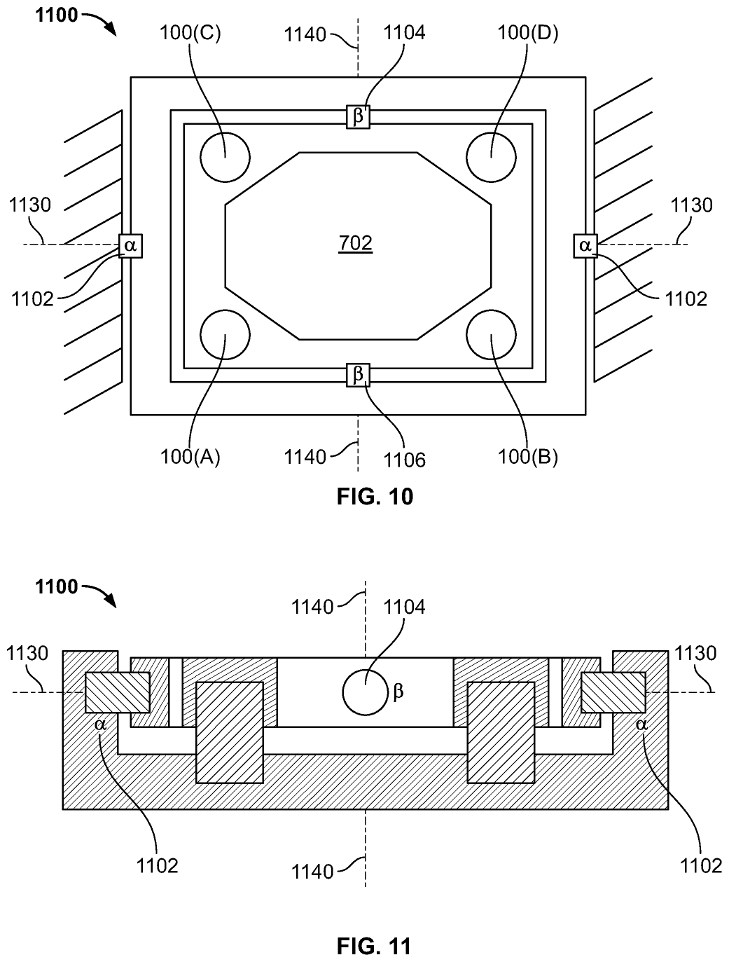

FIGS. 10 and 11 depict a gimbal assembly 1100, in accordance with an exemplary embodiment. Specifically, in various embodiments, FIG. 10 is a top perspective view, and FIG. 11 is a side perspective view of the gimbal assembly 1100. In various embodiments, the gimbal assembly 1100 corresponds to the rotational assembly 700 of FIGS. 7A, 7B, 7C, and FIG. 8. As illustrated in FIGS. 10 and 11, in various embodiments, the rotational assembly 700 of FIGS. 7A, 7B, 7C, and 8 comprises a gimbal assembly with two rotational axes. In various embodiments, this concept may be utilized around two rotational axes 1130, 1140, in order to achieve two angular misalignment degrees of freedom (namely, referred to herein as Alpha (α) 1102 and Beta (β) 1104 in FIGS. 10 and 11) with respect to the mating components.

Accordingly, a caged spring assembly is provided that includes a first end cap, a second end opposite the first end cap, a helical spring extending between the first and second end caps, and a locking post disposed inside the helical spring between the first and second end caps. In various embodiments, the locking post allows limited compression of the helical spring and prevents extension of the helical spring beyond a set point. Rotational assemblies are also provided that incorporate caged spring assemblies for coupling mating components together, and that accommodate potential misalignment of the mating components.

It will be appreciated that the caged spring assemblies of FIGS. 1-5 may vary in different embodiments. It will similarly be appreciated that the rotational assemblies of FIGS. 1-6, and the implementations of FIGS. 9-11, may also vary in different embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1.-6. (canceled)

7. A rotational apparatus comprising:
a rotational platform; and
a plurality of caged spring assemblies, each of the caged spring assemblies coupled to the rotational platform and comprising:
a first end cap coupled to the rotational platform;
a second end cap opposite the first end cap;
a helical spring extending between the first and second end caps, the helical spring including a first end and a second end that is opposite the first end; and
a locking post disposed inside the helical spring between the first and second end caps, wherein the locking post allows limited compression of the helical spring and prevents extension of the helical spring beyond a set point;
wherein:
the plurality of caged spring assemblies provide a preload to neutral feature for the apparatus;
the first end cap contacts the first end of the helical spring;
the second end cap contacts the second end of the helical spring; and
the locking post and the helical spring contact the first end cap and the second end cap at different respective locations;
wherein the rotation apparatus comprises a gimbal assembly having two rotational axes that achieve two angular misalignment degrees of freedom with respect to mating components.

8. (canceled)

9. The rotational apparatus of claim 7, wherein the plurality of caged spring assemblies comprise at least four caged spring assemblies each coupled near a corner of the rotational platform.

10. The rotational apparatus of claim 7, wherein the locking post prevents extension of the helical spring beyond the first end cap and the second end cap.

11. The rotational apparatus of claim 7, wherein the caged spring assembly provides restoring force along an axis, but not in orthogonal axes.

12. The rotational apparatus of claim 7, wherein the helical spring is loaded to a predetermined value, such that the caged spring assembly provides a resisting force only when the rotational platform is rotated to compress the helical spring further.

13. The rotational apparatus of claim 7, wherein the first end cap includes:
an upper surface; and
an opening formed in the upper surface;
wherein the first end cap further includes a plurality of grooves formed in the upper surface and surrounding the opening.

14. (canceled)

15. The rotational apparatus of claim 7, wherein the rotational apparatus is configured to be accommodative of a failure of a single one of the helical springs.

16. The rotational apparatus of claim 7, wherein the rotational apparatus is configured to couple mating components of a device.

17. The rotational apparatus of claim 16, wherein the rotational apparatus is configured to couple the mating components on a spacecraft.

18. The rotational apparatus of claim 7, wherein the rotational apparatus is configured to couple mating components of a fluid transfer coupler for a lunar gateway station.

19. A rotational apparatus comprising:
a rotational platform; and
a plurality of caged spring assemblies, the plurality of caged spring assemblies comprise four caged spring assemblies, each of the four caged spring assemblies coupled near a corner of the rotational platform and comprising:
a first end cap coupled to the rotational platform;
a second end cap opposite the first end cap;
a helical spring extending between the first and second end caps, the helical including a first end and a second end that is opposite the first end; and
a locking post disposed inside the helical spring between the first and second end caps, wherein the locking post allows limited compression of the helical spring and prevents extension of the helical spring beyond a set point;
wherein:
the plurality of caged spring assemblies provide a preload to neutral feature for the apparatus;
the rotational apparatus is configured to accommodate a degree of misalignment of two axially mating connector halves;
the first end cap contacts the first end of the helical spring;
the second end cap contacts the second end of the helical spring; and
the locking post and the helical spring contact the first end cap and the second end cap at different respective locations;
wherein the rotation apparatus comprises a gimbal assembly having two rotational axes that achieve two angular misalignment degrees of freedom with respect to mating components.

20. The rotational apparatus of claim 19, wherein the rotational apparatus is configured to couple mating components of a fluid transfer coupler for a lunar gateway station.

21. The rotational apparatus of claim 7, wherein the rotational platform comprises a flat rotational platform.

22. The rotational apparatus of claim 21, wherein the flat rotational platform extends continuously in a single planar direction between each of the plurality of caged spring assemblies.
